(19) United States
(12) Patent Application Publication
(10) Pub. No.: US 2005/0184799 A1
(43) Pub. Date: Aug. 25, 2005

(54) Semiconductor integrated circuit

(75) Inventor: Hiroyuki Kii, Osaka (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/058,292

(22) Filed: Feb. 16, 2005

(30) Foreign Application Priority Data
Feb. 25, 2004 (JP) P2004-049963

(51) Int. Cl. G05F 1/618

(52) U.S. Cl. 327/545

(57) ABSTRACT

A semiconductor integrated circuit according to the present invention comprises a power supply circuit for supplying an internal circuit with power, a first regulator for providing a regulated voltage for the power supply circuit, a second regulator for additionally providing the regulated voltage for the power supply circuit so as to compensate for a voltage drop level in the internal circuit, and a voltage drop determining unit for determining the drop of the power supply voltage in the internal circuit based on an output of a power supply voltage monitoring cell in the internal circuit and correspondingly activating the second regulator upon the determination of the generation of the voltage drop. As a component constituting the voltage drop determining unit, a voltage drop detecting circuit, an A/D conversion circuit, a D/A conversion circuit, or the like, can be used.

### BACKGROUND OF THE INVENTION

1. Field of the Invention

The present invention relates to a semiconductor integrated circuit, more particularly to a technology for stabilizing a power supply voltage in an internal circuit.

2. Description of the Related Art

Below is described an example of a technology for supplying an internal circuit disposed distantly from a power supply terminal with a power supply voltage undergoing a small voltage drop in a semiconductor integrated circuit. When a single power supply circuit of a constant voltage is provided at an intermediate position in a power supply wiring, the voltage drop is increased as the power supply wiring is lengthened. In order to avoid that, a plurality of constant-voltage power supply circuits is connected with appropriate intervals provided therebetween in the power supply wiring so that the power is indirectly supplied to the internal circuit from the constant-voltage power supply circuits.

However, the foregoing solution creates a problem that an area increase is generated in the semiconductor integrated due to the plurality of constant-voltage power supply circuits necessarily provided.

### BRIEF SUMMARY OF THE INVENTION

A semiconductor integrated circuit according to the present invention comprises:

a power supply circuit for supplying an internal circuit with power;

a first regulator for providing a regulated voltage for the power supply circuit;

a second regulator for additionally providing the regulated voltage for the power supply circuit so as to compensate for a voltage drop level in the internal circuit; and

a voltage drop determining unit for determining the drop of the power supply voltage in the internal circuit based on an output of a power supply voltage monitoring cell in the internal circuit and correspondingly activating the second regulator upon the determination of the generation of the voltage drop.

According to the foregoing constitution, when the drop of the power supply voltage in the internal circuit is detected by the voltage drop determining unit, the second regulator is activated. Thereby, the power supply voltage applied to the internal circuit can be automatically corrected. The regulated voltage outputted by the second regulator can be a minimal voltage required to compensate for the voltage drop level in the internal circuit. Therefore, a resultant area increase can be controlled in contrast to the case of providing the plurality constant-voltage power supply circuits.

Additional objects and advantages of the present invention will be apparent from the following detailed description of preferred embodiments thereof, which are best understood with reference to the accompanying drawings.

### BRIEF DESCRIPTION OF THE DRAWINGS

FIG. 1 is a block diagram illustrating a constitution of a semiconductor integrated circuit according to an embodiment 1 of the present invention.

FIG. 2 is a timing chart illustrating an operation of the semiconductor integrated circuit according to the embodiment 1.

FIG. 3 is a block diagram illustrating a constitution of a semiconductor integrated circuit according to an embodiment 2 of the present invention.

FIG. 4 is a timing chart illustrating an operation of the semiconductor integrated circuit according to the embodiment 2.

FIG. 5 is a block diagram illustrating a constitution of a semiconductor integrated circuit according to an embodiment 3 of the present invention.

FIG. 6 is a timing chart illustrating an operation in the case of not holding a monitoring reference voltage in the semiconductor integrated circuit according to the embodiment 3.

FIG. 7 is a timing chart illustrating an operation in the case of holding the monitoring reference voltage in the semiconductor integrated circuit according to the embodiment 3.

### DETAILED DESCRIPTION OF THE PREFERRED EMBODIMENTS

The voltage drop determining unit constituted as described according to the present invention specifically range in the following aspects. In one of the aspects, a voltage drop detecting circuit is used. An A/D conversion circuit is used in another aspect. A D/A conversion circuit is used in still another aspect. Below are given the details.

1. In one of the aspects, the voltage drop detecting circuit for detecting the drop of the power supply voltage in the internal circuit in response to the output of the power supply voltage monitoring cell in the internal circuit and correspondingly outputting a voltage drop detection signal constitutes the voltage drop determining unit. The details are given below.

A semiconductor integrated circuit according to the aspect comprises:

a power supply circuit for supplying an internal circuit with power in response to a regulated voltage from a first regulator;

a voltage drop detecting circuit for detecting a drop of a power supply voltage in the internal circuit in response to an output of a power supply voltage monitoring cell in the internal circuit and correspondingly outputting a voltage drop detection signal; and

a second regulator for additionally providing a regulated voltage to compensate for the voltage drop level in the internal circuit for the power supply circuit when the voltage drop detection signal from the voltage drop detecting circuit is effective.

According to the foregoing constitution, the drop of the power supply voltage in the internal circuit is detected by the voltage drop detecting circuit, and the power supply voltage applied to the internal circuit can be automatically corrected through the activation of the second regulator. The regulated voltage outputted by the second regulator can be a minimal voltage required to compensate for the voltage drop level in the internal circuit. Therefore, a resultant area increase can be controlled in contrast to the case of providing the plurality constant-voltage power supply circuits

2. A semiconductor integrated circuit according to the present invention may be constituted as follows. In place of the voltage drop detecting circuit in 1., the A/D conversion circuit incorporated in a semiconductor chip is used in the voltage drop determining unit. The A/D conversion circuit is adapted to A/D-convert the output of the power supply voltage monitoring cell in the internal circuit using any of cycles at the time of conversions of plurality of channels as a power supply detection cycle. The voltage drop determining unit further comprises a control circuit for comparing a result of the A/D conversion obtained by the A/D conversion circuit to a reference value and outputting an obtained result of the comparison in the form of the voltage drop detection signal. In the foregoing constitution, the power supply voltage is detected by means of the A/D conversion circuit instead of the voltage drop detecting circuit.

The A/D conversion circuit analogue-inputs the power supply voltage of the internal circuit therein and obtains digital data of the A/D conversion result through the A/D conversion. A comparator in the control circuit compares the power supply voltage of the internal circuit indicated by the data of the A/D conversion result to the reference value and obtains the voltage drop detection signal.

In the foregoing constitution, the power supply detection cycle is preferably a final cycle in the conversions of plurality of channels in the A/D conversion circuit, and the power supply detection cycle is more preferably constantly employed in the A/D conversion circuit except when reset is released and the A/D conversion is executed. When the power supply detection cycle is increased, the power supply voltage applied to the internal circuit can be stabilized with a higher precision.

3. A semiconductor integrated circuit according to the present invention may be constituted as follows. In place of the voltage drop detecting circuit in 1., the D/A conversion circuit incorporated in the semiconductor chip is used in the voltage drop determining unit. More specifically, the D/A conversion circuit for D/A-converting data from a data register used for converting user data in a first control circuit and outputting a result of the D/A conversion in the form of a D/A conversion result signal is used.

The voltage drop determining unit further comprises:

a second control circuit including a data register in which data used for generating a monitoring reference voltage is set and a control register for generating a D/A conversion start signal in response to timer interruption;

a selector for selecting from an output of the data register in the first control circuit and an output of the data register in the second control circuit and providing the selected output for the D/A conversion circuit;

an output line changeover circuit for dividing the output of the D/A conversion circuit into two systems and selectively outputting the divided outputs; and

a comparator for comparing the power supply voltage of the internal circuit to a monitoring reference voltage of the output line changeover circuit and outputting a result of the comparison in the form of the voltage drop detection signal. In the foregoing constitution, the power supply voltage is detected by means of the D/A conversion circuit instead of the voltage drop detecting circuit.

In the data register of the second control circuit, the data used for generating the monitoring reference voltage is set. In the power supply detection cycle for detecting the power supply voltage of the internal circuit, the selector selects the output of the data register of the second control circuit, while the output line changeover circuit outputs the monitoring reference voltage to the comparator as the output of the D/A conversion circuit. In the comparator, the power supply voltage of the internal circuit is compared to the monitoring reference voltage, and the voltage drop detection signal is obtained as a result of the comparison.

In the foregoing constitution, the monitoring reference voltage in the wiring system including from the output line changeover circuit through the comparator gradually drops as time advances, as a solution for which the monitoring reference voltage is refreshed. As a preferable constitution in order to realize the refreshing, the second control circuit is preferably adapted to generate the D/A conversion start signal at an underflow cycle of the timer interruption so that the monitoring reference voltage is reset.

Alternatively, an operational amplifier having a hold feature is preferably provided between the output line changeover circuit and the comparator. The hold feature of the operational amplifier serves to stabilize the monitoring reference voltage. In the constitution, it becomes unnecessary to regenerate the D/A conversion start signal.

Hereinafter, preferred embodiments of the semiconductor integrated circuit according to the present invention are described in detail referring to the drawings.

### EMBODIMENT 1

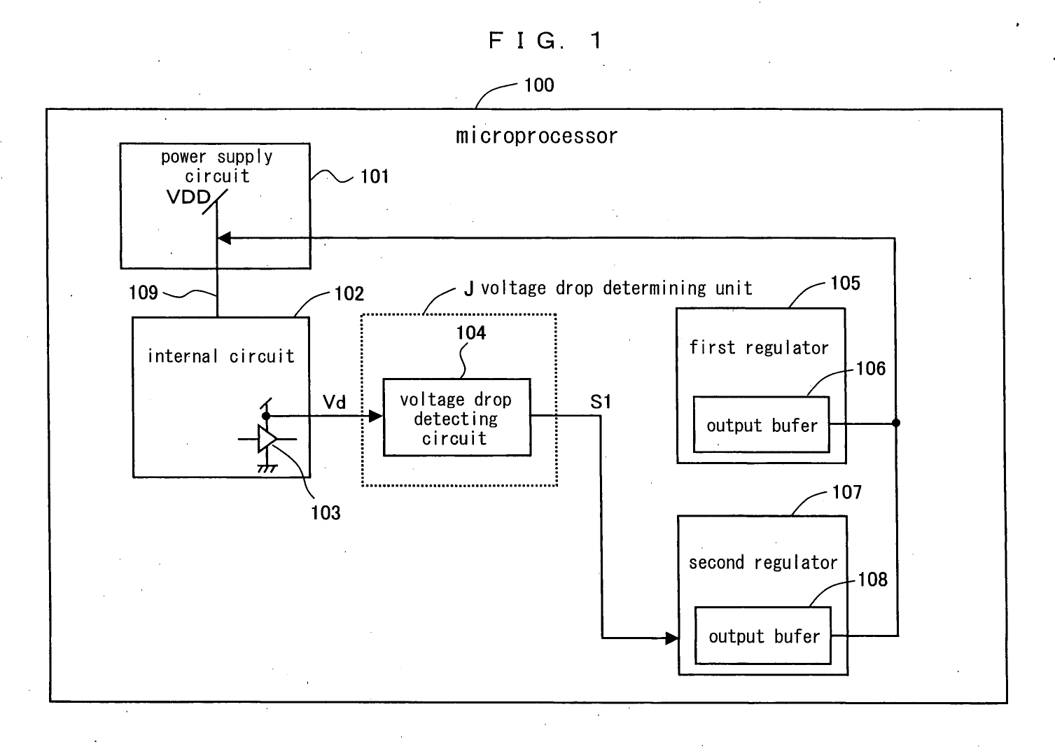

Referring to reference numerals in FIG. 1, 100 denotes a microprocessor, 101 denotes a power supply circuit, 102 denotes an internal circuit, 103 denotes a power supply voltage monitoring cell in the internal circuit 102, 104 denotes a voltage drop detecting circuit for detecting a drop of a power supply voltage in the internal circuit 102 based on a detection voltage Vd outputted from the power supply voltage monitoring cell 103, 105 denotes a first regulator, 106 denotes an output buffer in the first regulator 105, 107 denotes a second regulator, and 108 denotes an output buffer in the second regulator 107. According to the present embodiment, the voltage drop detecting circuit 104 serves as a voltage drop determining unit J.

When a power supply wiring 109 connecting the power supply circuit 101 and the internal circuit 102 is short, the drop of the power supply voltage applied to the internal circuit 102 is small. As the power supply wiring 109 is longer, the drop of the power supply voltage applied to the internal circuit 102 is possibly increased.

The power supply voltage in the microprocessor 100 is basically maintained at a constant voltage by the first regulator 105 alone, however, the constant voltage is complemented by an operation of the second regulator 107 when the voltage drops. More specifically, the voltage drop detecting circuit 104 monitors a fluctuation of the power supply voltage applied to the internal circuit 102 based on a detection voltage Vd of the power supply voltage monitoring cell 103 inside the internal circuit 102 and generates a voltage drop detection signal S1 and outputs it to the second regulator 107 when detecting that the voltage drop exceeding a certain level is generated. The second regulator 107 is activated in response to the voltage drop detection signal S1, and the output buffer 108 of the second regulator 107 outputs a current required for covering an increase of the power supply voltage corresponding to the voltage drop level. As a result, the power supply voltage applied to the internal circuit 102 is recovered to a constant voltage equal to that of a normal operation. A field-back group, which consists of the power supply circuit 101, internal circuit 102, voltage drop detecting circuit 104 and second regulator 107, serves to maintain the voltage applied to the internal circuit 102 at a constant level. When the operation of the field-back group is stabilized, the voltage drop detecting circuit 104 halts the output of the voltage drop detection signal S1. As a result, the second regulator 107 terminates its operation.

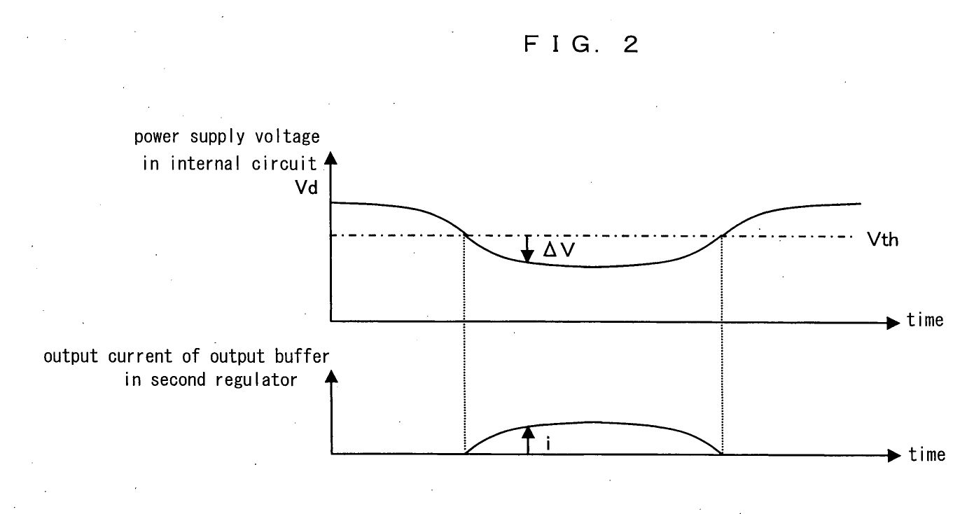

FIG. 2 denotes an operation of an automatic adjustment in the second regulator 107.

When the monitored detection voltage Vd is equal to or over a predetermined threshold Vth, the first regulator 105 alone serves to control the voltage, in which case the second regulator 107 is not operated. The current outputted from the output buffer 108 is therefore nil.

When the monitored detection voltage Vd falls below the predetermined threshold Vth, the second regulator 107 is activated and the output buffer 108 outputs a current i corresponding to a differential ΔV between the threshold Vth and the power supply voltage. When the power supply voltage is recovered in the foregoing operation and starts to exceed the threshold Vth, the second regulator 107 halts its operation allowing the first regulator 105 alone to control the voltage again.

An area of the output buffer 108 of the second regulator 107 can be made to be smaller than an area of the output buffer 106 of the first regulator 105 because the second regulator 107 is only required to have a capacity of covering the level of the voltage drop. Further, the second regulator 107 is operated only when necessary, which controls the power consumption.

When only the internal circuit 102, in which the voltage drop is more possibly generated, constitutes the field-back group, a larger effect of the area reduction can be achieved.

### EMBODIMENT 2

In an embodiment 2 of the present invention, the voltage drop in the internal circuit is detected by means of an A/D conversion block without using the voltage drop detecting circuit according to the embodiment 1.

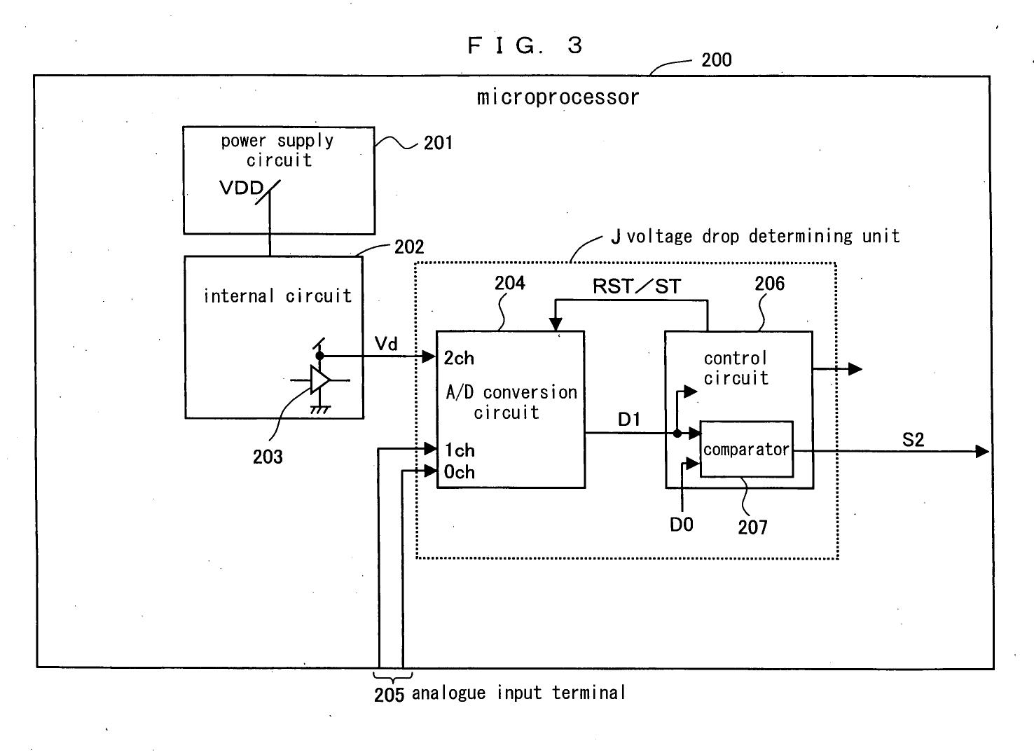

Referring to reference numerals in FIG. 3, 200 denotes a microprocessor, 201 denotes a power supply circuit, 202 denotes an internal circuit, 203 denotes a power supply voltage monitoring cell in the internal circuit 202, 204 denotes an A/D conversion circuit, 205 denotes analogue input terminals, 206 denotes a control circuit, and 207 denotes a comparator in the control circuit 206. A detection voltage Vd outputted from the power supply voltage monitoring cell 203 is assigned to an analogue (2ch) exclusively used for detecting the power supply voltage in the A/D conversion circuit 204. In the present embodiment, the A/D conversion circuit 204 and the control circuit 206 constitute a voltage drop determining unit J.

A fluctuation of the power supply voltage applied to the internal circuit 202 is monitored via the power supply voltage monitoring cell 203 in the internal circuit 203, and the detection voltage Vd is outputted to the A/D conversion circuit 204. The A/D conversion circuit 204 whose analogue input terminals receives the input of the detection voltage Vd executes a predetermined analogue-digital conversion and outputs a data D1 representing a result of the A/D conversion to the control circuit 206. The comparator 207 of the control circuit 206 compares the inputted data D1 of the A/D conversion result to a reference value D0. When the drop of the power supply voltage in the internal circuit 202 is not generated, an output of the comparator 207 is at “L” level, whereas the data D1 of the A/D conversion result falls below the reference value D0 when the voltage drop is generated. The comparator 207 correspondingly sets a voltage drop detection signal S2 to “H” level and outputs it.

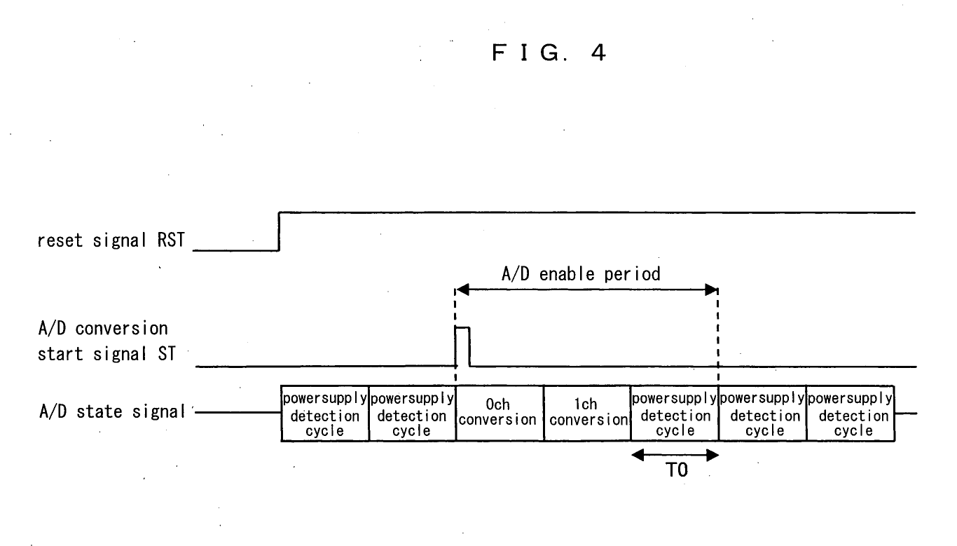

FIG. 4 is a timing chart of a power supply detection cycle in the A/D conversion circuit 204.

The A/D conversion circuit 204 is initialized in response to a reset signal RST outputted from the control circuit 206, and executes a 0-channel A/D conversion and, thereafter, 1-channel A/D conversion in response to the receipt of an A/D conversion start signal ST outputted from the control circuit 206. The A/D conversions of two channels are now completed. The A/D conversion circuit 204 further generates the power supply detection cycle in a subsequent TO period of a final cycle, acquires the detection voltage Vd from the internal circuit 202, executes the A/D conversion, and outputs the relevant data D1 of the A/D conversion result to the control circuit 206.

The power supply detection cycle is basically set when reset is released, and it is preferable that the power supply detection cycle be always set, except for the cycle of the A/D conversion, in the state in which the reset is released.

### EMBODIMENT 3

In an embodiment 3 of the present invention, the voltage drop in the internal circuit is detected by means of a D/A conversion block without using the voltage drop detecting circuit according to the embodiment 1.

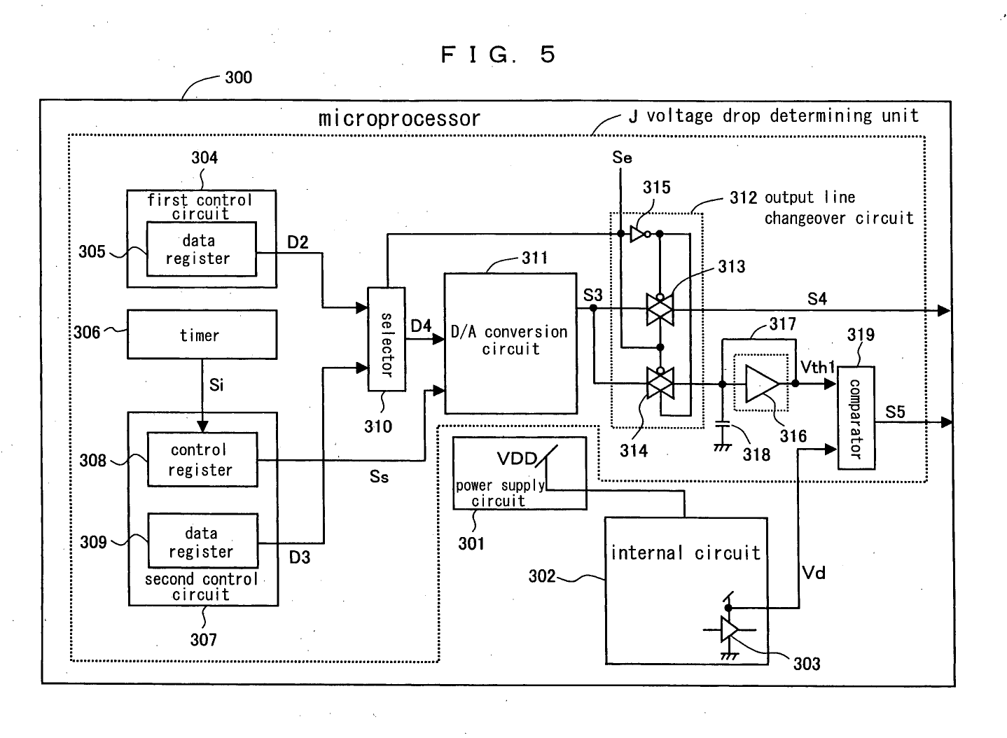

Referring to reference numerals in FIG. 5, 300 denotes a microprocessor, 301 denotes a power supply circuit, 302 denotes an internal circuit, 303 denotes a power supply voltage monitoring cell in the internal circuit 302, 304 denotes a first control circuit, 305 denotes a data register in the internal circuit 304, 306 denotes a timer, 307 denotes a second control circuit, 308 denotes a control register in the second control circuit 307, 309 denotes a data register, 310 denotes a selector for selecting from an output data D2 of the data register 305 in the first control circuit 304 and an output data D3 of the data register 309 in the second control circuit 307, 311 denotes a D/A conversion circuit, 312 denotes an output line changeover circuit for dividing an output of the D/A conversion circuit 311 into two systems and executing a changeover between the divided outputs, 313 denotes a first analogue switch in the output line changeover circuit 312, 314 denotes a second analogue switch, 315 denotes an inverter, 316 denotes an operational amplifier, 317 denotes a feedback wiring, 318 denotes a capacitor, and 319 denotes a comparator for comparing a monitoring reference voltage Vth1 outputted from the operational amplifier 316 and a detection voltage Vd outputted from the power supply voltage monitoring cell 303. In the data register 309 of the second control circuit 307 is set the data D3 for detecting the power supply voltage. In the present embodiment, the mentioned components other than the power supply circuit 301 and the internal circuit 302 constitute a voltage drop determining unit J.

In a user data conversion cycle, an enable signal Se is set to the “L” level. The selector 310 selects the user data D2 outputted from the data register 305 of the first control circuit 304 and inputs the selected user data D2 to the D/A conversion circuit 311 as an input data D4. Further, because the enable signal Se is set to the “L” level, the first analogue switch 313 of the output line changeover circuit 312 is turned on, the second analogue switch 314 of the output line changeover circuit 312 is turned off, and a D/A conversion result signal S3 is thereby outputted from the D/A conversion circuit 311 as a D/A conversion result signal S4 via the first analogue switch 313.

In the arrival of a power supply detection cycle, the timer 306 outputs an interruption signal Si to the control register 308 of the second control circuit 307, in response to which the second control circuit 307 is activated to thereby output a D/A conversion start signal Ss to the D/A conversion circuit 311. Concurrently, the enable signal Se is set to “H” level, and the selector 310 selects the data D3 for detecting the power supply voltage outputted from the data register 309 of the second control circuit 307 and inputs the selected data D3 to the D/A conversion circuit 311 as the input data D4. Because the enable signal S3 is set to the “H” level, the first analogue switch 313 of the output line changeover circuit 312 is turned off, the second analogue switch 314 of the output line changeover circuit 312 is turned on, and the D/A conversion result signal Se is outputted from the D/A conversion circuit 311 as the monitoring reference voltage Vth1 via the second analogue switch 314 and the operational amplifier 316.

The comparator 309 compares the detection voltage Vd from the power supply voltage monitoring cell 303 of the internal circuit 303 to the monitoring reference voltage Vth1 and outputs a result of the comparison as a voltage drop detection signal S5. When the detection voltage Vd is equal to or over the monitoring reference voltage Vth1, the voltage drop detection signal S5 is at the “L” level. When the detection voltage Vd falls below the monitoring reference voltage Vth1, the voltage drop detection signal S5 is at the “H” level.

The operational amplifier 316 differently operates when the feedback wring 317 and the capacitor 318 are absent and when they are present. The difference generated between the two cases is described below.

The feedback wiring 317 and the capacitor 318 serve to equip the operational amplifier 316 with a hold feature through a voltage feedback.

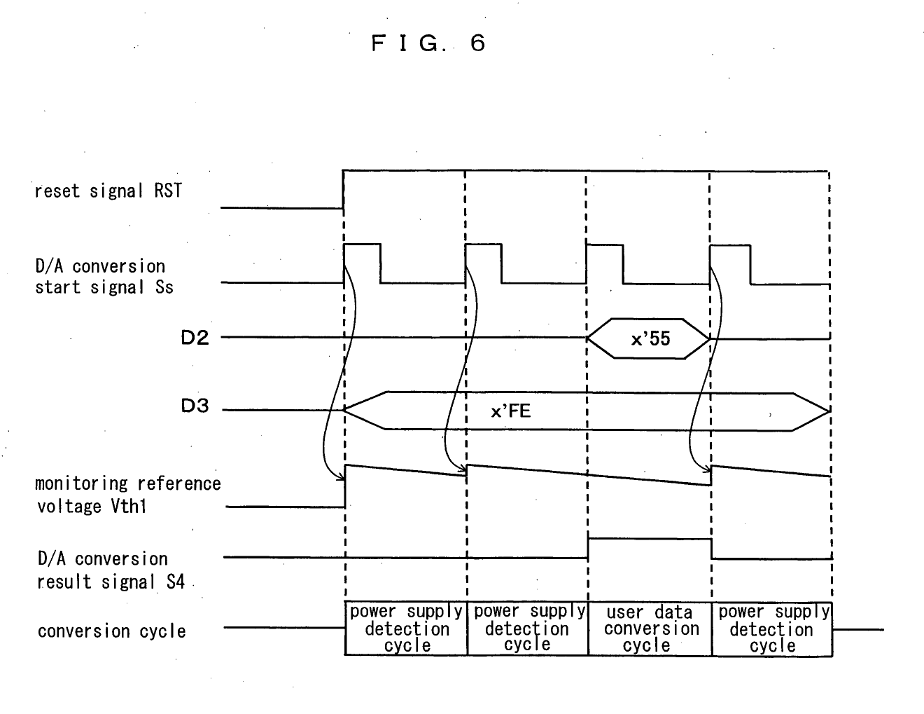

An operation of the operational amplifier 316 in the case in which the hold feature is not effective is described referring to a timing chart of FIG. 6.

In the arrival of the power supply detection cycle, the monitoring reference voltage Vth1 rises in conjunction with a rise of the D/A conversion start signal Ss. However, the monitoring reference voltage Vth1 gradually drops through a discharge occurring as time advances. The drop of the monitoring reference voltage Vth1 is unfavorable. Then, the timer 306 activates the D/A conversion start signal Ss again at an underflow cycle thereof, as a result of which the monitoring reference voltage Vth1 is recovered. The recovery is not carried out in the user data conversion cycle.

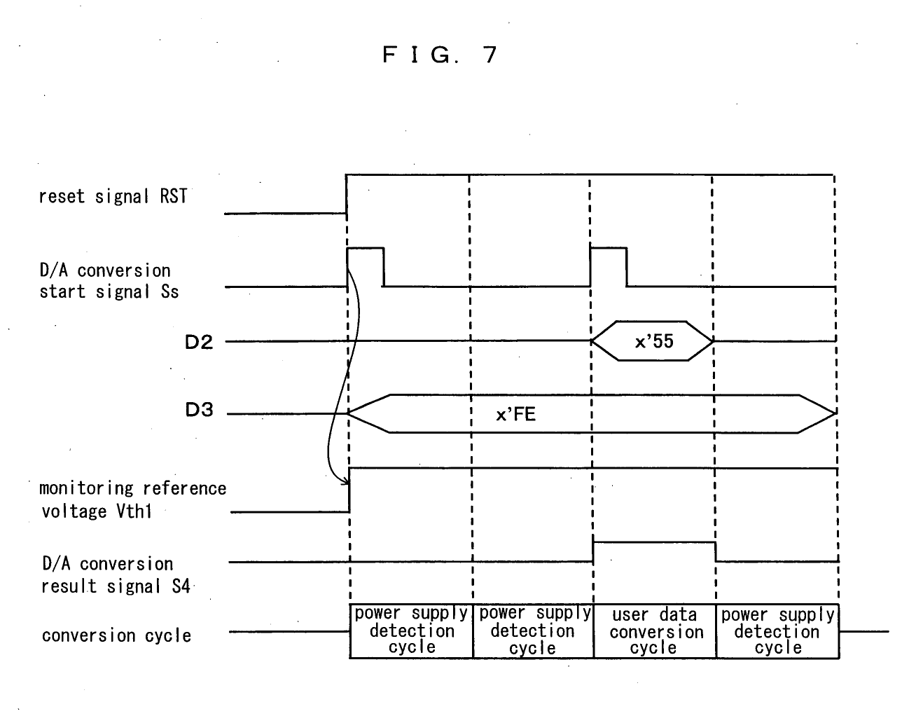

Next, An operation of the operational amplifier 316 in the case in which the hold feature is effective is described referring to a timing chart of FIG. 7.

In the arrival of the power supply detection cycle, the monitoring reference voltage Vth1 rises in conjunction with the activation of the D/A conversion start signal Ss. A potential of the monitoring reference voltage Vth1 is immediately stabilized in a smoothening step through the voltage feedback and charging of the capacitor 318 in the operational amplifier 316. Therefore, it becomes unnecessary to reactivate the D/A conversion start signal Ss. The stabilized potential of the monitoring reference voltage Vth1 is also maintained in the user data conversion cycle.

The present invention is not limited to the foregoing embodiments and can be implemented in various modifications within the scope of its technical idea.

As thus far described, according to the present invention, the drop of the power supply voltage in the internal circuit can be automatically corrected by means of the detecting regulators, and the regulated voltage which is outputted can be of a minimal level required to compensate for the voltage drop level in the internal circuit. Therefore, the area increase can be controlled in comparison to the case of providing the plurality of constant-voltage power supply circuits.

Further, the voltage drop in the internal circuit can be detected by means of the A/D conversion circuit instead of the voltage drop detecting circuit, or the voltage drop in the internal circuit can be detected by means of the D/A conversion circuit instead of the voltage drop detecting circuit.

The present invention is advantageous as a technology for automatically correcting and stabilizing a power supply voltage applied to an internal easily undergoing a drop of a power supply voltage in a semiconductor integrated circuit in which a finer structure and a lower power supply voltage are being pursued.

1. A semiconductor integrated circuit comprising:
a power supply circuit for supplying an internal circuit with power;
a first regulator for providing a regulated voltage for the power supply circuit;
a second regulator for additionally providing the regulated voltage for the power supply circuit so as to compensate for a voltage drop level in the internal circuit; and
a voltage drop determining unit for determining the drop of the power supply voltage in the internal circuit based on an output of a power supply voltage monitoring cell in the internal circuit and correspondingly activating the second regulator upon the determination of the generation of the voltage drop.

2. A semiconductor integrated circuit as claimed in claim 1, wherein
a voltage drop detecting circuit for detecting the drop of the power supply voltage in the internal circuit in response to the output of the power supply voltage monitoring cell in the internal circuit and outputting a voltage drop detection signal constitutes the voltage drop determining unit.

3. A semiconductor integrated circuit as claimed in claim 1, wherein
an A/D conversion circuit for A/D-converting the output of the power supply monitoring cell in the internal circuit using any of cycles in executing conversions of a plurality of channels as a power supply detection cycle and a control circuit for comparing data representing a result of the A/D conversion by the A/D conversion circuit to a reference value and outputting a result of the comparison as the voltage drop detection signal constitute the voltage drop determining unit.

4. A semiconductor integrated circuit as claimed in claim 3, wherein
the A/D conversion circuit employs the power supply detection cycle as a final cycle in executing the conversions of the plurality of channels.

5. A semiconductor integrated circuit as claimed in claim 3, wherein
the A/D conversion circuit always employs the power supply detection cycle except when reset is released and the A/D conversion is executed.

6. A semiconductor integrated circuit as claimed in claim 1, wherein the voltage drop determining unit comprises:
a first control circuit in which a data register for converting user data is incorporated;
a second control circuit including a data register in which data used for generating a monitoring reference voltage is set and a control register for generating a D/A conversion start signal in response to timer interruption;
a selector for selecting from an output of the data register in the first control circuit and an output of the data register in the second control circuit and providing the selected output for the D/A conversion circuit;
an output line changeover circuit for dividing the output of the D/A conversion circuit into two systems and selectively outputting the divided outputs; and
a comparator for comparing the power supply voltage of the internal circuit to a monitoring reference voltage of the output line changeover circuit and outputting a result of the comparison in the form of the voltage drop detection signal.

7. A semiconductor integrated circuit as claimed in claim 6, wherein
the second control circuit is adapted to generate the D/A conversion start signal at an underflow cycle of the timer interruption and reset the monitoring reference voltage.

8. A semiconductor integrated circuit as claimed in claim 6, wherein
an operational amplifier having a hold feature is provided between the output line changeover circuit and the comparator.
